(19) United States
(12) Patent Application Publication
(10) Pub. No.: US 2004/0089583 A1
(43) Pub. Date: May 13, 2004

(54) Portable pet food package

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Clyde I. Coughenour, 16607 Sutton Place, Woodbridge, VA, 22191, US

(21) Appl. No.: 10/289,253

(22) Filed: Nov. 7, 2002

(51) Int. Cl. B65D 1/34; B65D 6/04

(52) U.S. Cl. 206/561; 206/564

(57) ABSTRACT

A portable, disposable pet feeding container having two thin walled primary bowls held by a relatively thick bowl support. The bowl bottom is roughened to resist slippage during use and the top rim is positioned essentially horizontally on essentially vertically extending bowl walls above the bowl support to resist cross contamination and provide a sealing contact line. An adhesive coated lid seals in the bowl contents prior to use. An auxiliary bowl can be placed within a primary bowl or the base of one bowl extended beneath the other to increase volume, weight and traction of the one bowl.

### BACKGROUND OF THE INVENTION

1. Field of the Invention

A portable disposable container has two bowls for consumables, secured together by a support, with rims above the support and roughened bottoms, an auxiliary bowl can be placed in one of the bowls.

2. Description of Related Art

Portable disposable food containers are common in the art. Plural adjacent compartment food containers with individual portions sealed and easily separated with food for convenient use are common with D. St. Pierre et al, U.S. Pat. No. 5,904,263, issued 18 May 1999, an example. Plural adjacent compartment food containers with individual portions for different foods sealed for convenient use are common with G. Hustad et al, U.S. Pat. No. 5,657,874, issued 19 Aug. 1997, an example.

Providing convenient portable disposable food containers is common. J. Zarski, U.S. Pat. No. 5,947,056, issued 7 Sep. 1999, and T. King et al, U.S. Pat. No. 5,752,464, issued 19 May 1998, are examples of duel container pet feeding containers that are pivotable together and easily transportable for food and water with sealed closures for each container.

M. Gorlick et al, U.S. Pat. No. 5,901,848, issued 11 May 1999, and D. Donovan, U.S. Pat. No. 3,530,917, issued 29 Sep. 1970, are examples of adjacent food containers with a peelable film cover on a rigidified flange to seal in the contents.

Providing for container resistance to movement while the contents are consumed by pets is old with A. Sharkan et al, U.S. Pat. No. 5,209,184, issued 11 May 1993, and A. Demko, U.S. Pat. No. 4,949,678, issued 21 Aug. 1990, examples.

### SUMMARY OF THE INVENTION

Portable disposable food containers are integral with or separable from a bowl support. The base of the bowls are roughened to resist sliding on a support surface and the top has an essentially horizontal rim for sealing the contents in the containers with a removable lid. The rims are essentially vertically positioned above the bowl support to resist cross-contamination or mixing. An auxiliary bowl can be placed within one of the bowls.

### BRIEF DESCRIPTION OF THE DRAWINGS

FIG. 1 is a top view of the food container.

FIG. 2 is a side view of the food container.

FIG. 3 is a side view of the food container bowl of FIG. 2 with an auxiliary bowl therein.

FIG. 4 is a side view modification of the food container bowl shown in FIG. 3.

### DESCRIPTION OF THE PREFERRED EMBODIMENTS

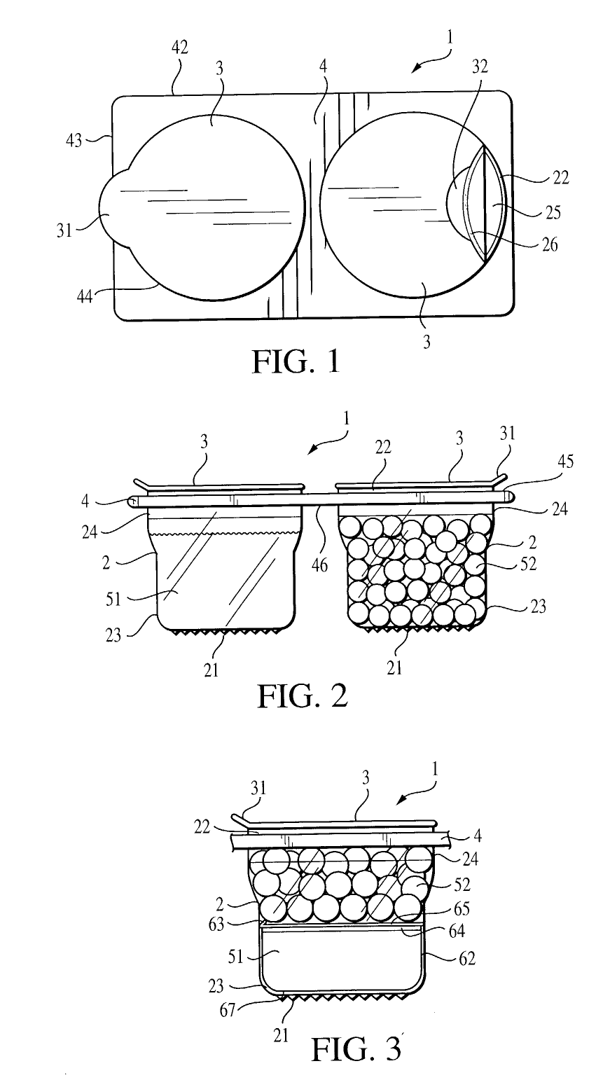

The food container 1 is shown in FIGS. 1 and 2. FIG. 1 is a top view showing one lid 3 over a primary bowl, sealing the contents in the bowl, and another lid 3 peeled back to reveal the bowl rim 22, bowl interior 25, adhesive free area 32 of tab 31 and adhesive 26 on the lid under side. FIG. 2 is a side view showing the bowl 2 irregular base 21, lower container smaller diameter 23, raised rim 22, over support 4 with lids 3.

The present portable food container 1is designed primarily for feeding pets in a hurry or for convenience when on the road. By simply pulling back on the tab 31 the removable lids 3 are separated from the primary bowl 2 and the container can be placed on the floor or ground. A meal consisting of water 51 and a dry or prepared moist mixture 52 is available to a pet. The primary combination consists of the lids 3 and integral or separate bowls 2 and bowl support 4.

The bowl 2 has an essentially horizontal rim 22 that extends above the bowl support 4 a short distance on essentially vertical bowl walls. Having the rim raised above the support 4 helps prevent food being consumed from tumbling or being knocked into the liquid when, for example, solid food 52 and water 51 are being provided. The raised rim 22 also acts to prevent liquid, being lapped up, from draining into the solid or other food compartment and wetting it, for example, when dry food is being fed to a pet. Having the rims raised also provides a line of contact for sealing removable lids. It is easier and more reliable to form a seal between the container and lid with the narrow (1/16-¼ in.) rim. Pressure can be placed and concentrated at and around the rim to provide a continuous seal line between the rim and lid using the preferably pressure sensitive adhesive 26 on the lower surface of the lid 3.

The base of the bowls 2 is formed in an irregular shape 21 that functions to prevent slipping, as food or drink is consumed, and to strengthen the container. The irregularities 21 can be in the form of pyramids or relatively sharp concentric circles, etc., so that the irregularities on the base will engage with the ground , grass, concrete, etc., when placed on the ground. This type surface resists sliding and overturning when the food or drink in the container is consumed.

The food bowls 2 are spaced and secured together by a bowl support 4. The bowl support is a relatively rigid essentially flat member that extends beyond the bowl rims 22 on all sides and is secured to the bowls near the upper extremes 24 and top of the bowls a short distance below the bowl rims. The bowl support 4 can be an independent, essentially rectangular rigid member with sides 42 and ends 43 and upper surface 45 and lower surface 46 and openings 44 to frictionally receive independent bowl containers 2. This arrangement permits consumption from more than one bowl when unequal amounts are being consumed from the two bowls. The removal and replacement of bowls is aided by having the bowls with a slightly smaller base 23 than the top 24. This allows easy insertion of the bowl base 23 with a limited top area 24 force fit. A small 1 to 3 degree taper on the bowl upper essentially vertical wall extreme 24 insures a tight fit while maintaining a space between the bowl support and bowl rim 22. As an alternative, the bowl 2 and bowl support 4 can be molded as a single unit with the bowl support 4 thicker and more rigid than the bowls 2. The bowls in either instance are relatively thin with relatively flexible sides and base. The thickness of the bowl supports is preferably thicker than the thickness of the bowls in the order of being two to one or more. With the thickness of the bowls being preferably from 0.010 to 0.025 inch the bowl support can be from 0.030 to 0.090 inch.

The lids 3 are impermeable resilient paper, plastic or a laminate of the two preferably having an adhesive 26 on the surface facing the container, either covering the entire lower surface 32 or around the periphery where the rim 22 of the container is contacted.

FIG. 3 shows the use of an auxiliary bowl. During some periods of time, such as during hot weather, it may be necessary to provide more water than food. It may also be desirable to increase the weight of the package to hold it in place on the ground. Since the weight of the water volume is normally greater than that of the food, to increase the weight of the package, and to provide more water, an auxiliary water space can be provided under the food in the food bowl. To do this a second inwardly extending rim 64 can be molded into the bowl or a separate auxiliary bowl 62 can be inserted into the bowl 2. The auxiliary bowl can be provided with water 51 and a lid 65, having a tab 63, that is placed on the auxiliary rim 64.

The auxiliary water bowl 62 is inserted into the smaller base 23 of the food bowl 2 with its base 67 resting on the food bowl irregular shape base 21. The second inwardly extending rim 64 of the auxiliary water bowl 62 is covered with an auxiliary lid 65 having a tab 63 for convenient removal of the lid. As with the lid 3, the lid 65 seals the water in the auxiliary container to prevent contamination of the food. After placement of the auxiliary water bowl 62 in the bowl 2, food 52 is placed on top of it and the lid 3 is sealed in place over the two.

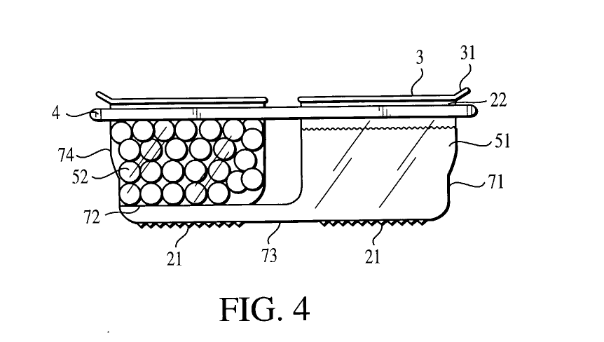

FIG. 4 is a modification of FIG. 3 wherein the bowl 71, intended for water, is elongated 73 to extend under the bowl 74 to add water volume, weight and traction with both roughened areas 21 on the base. The bowl 74 either rests on the upper extension 72 of the bowl 71 or is formed as an integral part of the elongation.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A portable disposable consumable product container comprising:
a bowl support having sides, ends, an upper surface and a lower surface;
bowls spaced and supported by said bowl support;
said bowls having walls with an upper end having an opening and a lower end closed;
said bowls upper end walls protruding essentially vertically above said bowl support upper surface and terminating in narrow essentially horizontal rims;
said bowls upper open ends having removable lids for sealing in consumables.

2. A portable disposable consumable product container as in claim 1 wherein:
said bowl upper narrow end horizontal rims provide a pressure sensitive sealing surface for said removable lid.

3. A portable disposable consumable product container as in claim 2 including:
said removable lids having an upper and a lower surface;
a pressure sensitive adhesive on said removable lids lower surface for sealing said removable lid to said narrow, essentially horizontal bowl rims.

4. A portable disposable consumable product container as in claim 1 wherein:
said bowl closed lower end is roughened to resist sliding when said container is placed on a surface.

5. A portable disposable consumable product container as in claim 1 wherein:
said bowls have a thickness that is less than one-half the thickness of said bowl support.

6. A portable disposable consumable product container as in claim 5 wherein:
said bowls and said bowl support are molded as one integral component.

7. A portable disposable consumable product container as in claim 1 wherein:
said bowls upper ends are larger than said bowls lower ends.

8. A portable disposable consumable product container as in claim 7 wherein:
said bowl support has openings for the reception of said bowls.

9. A portable disposable consumable product container as in claim 8 wherein:
said bowl support openings are essentially the same size as said bowls upper ends for frictionally holding said bowls in position within said bowl support.

10. A portable disposable consumable product container as in claim 9 wherein:
said bowls upper ends are slightly tapered so as to insure a tight frictional fit with said bowl support.

11. A portable disposable consumable product container as in claim 3 wherein:
said bowl closed lower end is roughened to resist sliding when said container is placed on a surface.

12. A portable disposable consumable product container as in claim 11 wherein:
said bowls have a thickness that is less than one-half the thickness of said bowl support.

13. A portable disposable consumable product container as in claim 10 wherein:
said bowl closed lower end is roughened to resist sliding when said container is placed on a surface.

14. A portable disposable consumable product container as in claim 10 wherein:
said bowls have a thickness that is less than one-half the thickness of said bowl support.

15. A portable disposable consumable product container as in claim 14 wherein:
said removable lids have an upper and a lower surface;
a pressure sensitive adhesive on said removable lids lower surface for sealing said removable lid to said bowl rim.

16. A portable disposable consumable product container as in claim 1 including:
an auxiliary bowl;
said auxiliary bowl walls being shorter than said bowl so that said auxiliary bowl can be placed within said bowl.

17. A portable disposable consumable product container as in claim 16 wherein:
said bowls upper ends are larger than said bowls lower ends;
said auxiliary bowl fits within said bowl lower end.

18. A portable disposable consumable product container as in claim 17 wherein:
said auxiliary bowl has an inwardly extending rim;
an auxiliary lid extends over said auxiliary bowl and is attached to said auxiliary bowl inwardly extending rim.

19. A portable disposable consumable product container as in claim 1 wherein:
said bowls have different shapes with one bowl having a lower, elongated extension that extends under the other bowl.

20. A portable disposable consumable product container as in claim 19 wherein:
roughened areas are under said one bowl and under said lower elongated extension to resist sliding when said container is placed on a surface.
